(19) United States
(12) Patent Application Publication
(10) Pub. No.: US 2005/0018654 A1
(43) Pub. Date: Jan. 27, 2005

(54) System and method for delivery of audio content into telephony devices

(76) Inventors: Sunny P. Smith, Kechi, KS (US); David A. Raehpour, Wichita, KS (US)

Correspondence Address: SWIDLER BERLIN SHEREFF FRIEDMAN, LLP, 3000 K STREET, NW, BOX IP, WASHINGTON, DC, 20007, US

(21) Appl. No.: 10/626,618

(22) Filed: Jul. 25, 2003

(51) Int. Cl. H04L 12/66

(52) U.S. Cl. 370/352; 370/389

(57) ABSTRACT

An audio content interface system, computer program product, and method of operation, for provides audio content to a user without the user having to use a computer system, or other computation device. The audio content interface system provides audio content stored on a data communications network to an end-user over a telecommunications network, the audio content interface system communicatively connected to the data communications network and the telecommunications network, and comprises a media delivery interface module operable to interface with the end-user over the telecommunications network, accept a request for audio content from the end-user, access audio content over the data communications network, and provide the audio content to the end-user over the telecommunications network and a content address translation module operable to provide an address mapping between an address of audio content stored on the data communications network and an address of the end-user on the telecommunications network.

### FIELD OF THE INVENTION

The present invention relates to a system, method, and computer program product for providing audio content stored on a data communications network to an end-user over a telecommunications network.

### BACKGROUND OF THE INVENTION

As the Internet has grown, a number of Internet media functions have become popular. One such function is the provision of streaming audio content from a Web site to a user browsing that Web site using a computer system and a browser program. For example, a user may browse to a Web site and obtain live or recorded streaming audio content of many events or performances. However, this functionality requires the use of a computer system, or other computation device, which is communicatively connected to the Internet. It is not always practical for a user to possess such equipment. Thus, a need arises for a technique by which a user may obtain audio content without the user having to use a computer system, or other computation device.

### SUMMARY OF THE INVENTION

The present invention provides audio content to a user without the user having to use a computer system, or other computation device.

In one embodiment of the present invention, an audio content interface system for providing audio content stored on a data communications network to an end-user over a telecommunications network, the audio content interface system communicatively connected to the data communications network and the telecommunications network, comprises a media delivery interface module operable to interface with the end-user over the telecommunications network, accept a request for audio content from the end-user, access audio content over the data communications network, and provide the audio content to the end-user over the telecommunications network and a content address translation module operable to provide an address mapping between an address of audio content stored on the data communications network and an address of the end-user on the telecommunications network.

The audio content may be provided to the end-user over a voice connection of the telecommunications network.

The media delivery interface module may be further operable to perform the steps of receiving a telephone call from the end-user, presenting a user interface to the end-user, accepting a selection of audio content from the end-user, and providing the selected audio content to the end user. The step of presenting a user interface to the end-user may comprise the step of presenting a different user interface, audio content selections, and/or audio content to the end-user based on a telephone number dialed by the end-user to place the telephone call. The step of providing the selected audio content to the end user may comprise the steps of requesting the selected audio content over the data communications network from a source of audio content using an indicator of a location of the audio content, receiving over the data communications network the requested audio content, and providing the requested audio content to the end-user over the telecommunications network.

In one aspect of the present invention, there may be a plurality of end-users requesting the same audio content and the step of providing the selected audio content to the end-user may comprise the step of providing the audio content to all end-users that requested the audio content. The requested audio content may be live audio content and the step of providing the audio content to all end-users that requested the audio content may comprise the step of providing the audio content to an end-user from a point in the audio content at which the end-user requested the audio content. The requested audio content may be recorded audio content and the step of providing the audio content to all end-users that requested the audio content may comprise the steps of providing the audio content to an end-user from a point in the audio content at which the end-user requested the audio content and repeating providing the audio content from the start of the audio content. The requested audio content may be recorded audio content and the step of providing the audio content to all end-users that requested the audio content may comprise the steps of providing the audio content from the start of the audio content for each end-user that requests the audio content.

In one aspect of the present invention, the media delivery interface module is further operable to perform the step of controlling access and/or input to the media delivery interface module. The step of controlling access and/or input to the media delivery interface module may comprise at least one of providing password control to establish origination connections, metering to control, limit, and/or bill based on a length or size of the audio content, a number of simultaneous accesses to the audio content, a number of total accesses to the audio content, a time of access to the audio content, and/or periodic charges, limiting input sources to hardwired connections, accept connection only from designated sources, controlling which pieces of content are available based on an access method, login, and/or interconnect, importing an external permissions file, providing a sample audio content, then requiring billing information to continue providing audio content, blocking specific calling numbers automatically after sample audio content has been provided, until payment is made, and blocking specific calling numbers permanently.

In one aspect of the present invention, the media delivery interface module is further operable to perform the step of providing advertising content to the end-user. The step of providing advertising content to the end-user may comprise at least one of providing advertising content by class of service, providing advertising content based on selected audio content, providing advertising content before and/or after providing selected audio content, and providing advertising content based on a timed advertising interval.

In one aspect of the present invention, the media delivery interface module is further operable to perform the step of requesting the selected audio content from a Web server. The step of the requesting the selected audio content from a Web server may comprise the step of requesting the selected audio content from the Web server using a uniform resource locator. The data communications network may be the Internet.

In one aspect of the present invention, the media delivery interface module is further operable to perform the step of requesting the selected audio content from an audio content server. The step of the requesting the selected audio content from the audio content server may comprise the step of requesting the selected audio content from the audio content server using a uniform resource locator. The data communications network may be the Internet.

### BRIEF DESCRIPTION OF THE DRAWINGS

The details of the present invention, both as to its structure and operation, can best be understood by referring to the accompanying drawings, in which like reference numbers and designations refer to like elements.

FIG. 1 is an exemplary block diagram of a network system in which the present invention may be implemented.

FIG. 2 is an exemplary block diagram of the audio content interface system shown in FIG. 1.

FIG. 3 is an exemplary block diagram of an audio content interface system shown in FIG. 1.

FIG. 4 is an exemplary data flow diagram of a process of operation of a media delivery interface shown in FIG. 2.

### DETAILED DESCRIPTION OF THE INVENTION

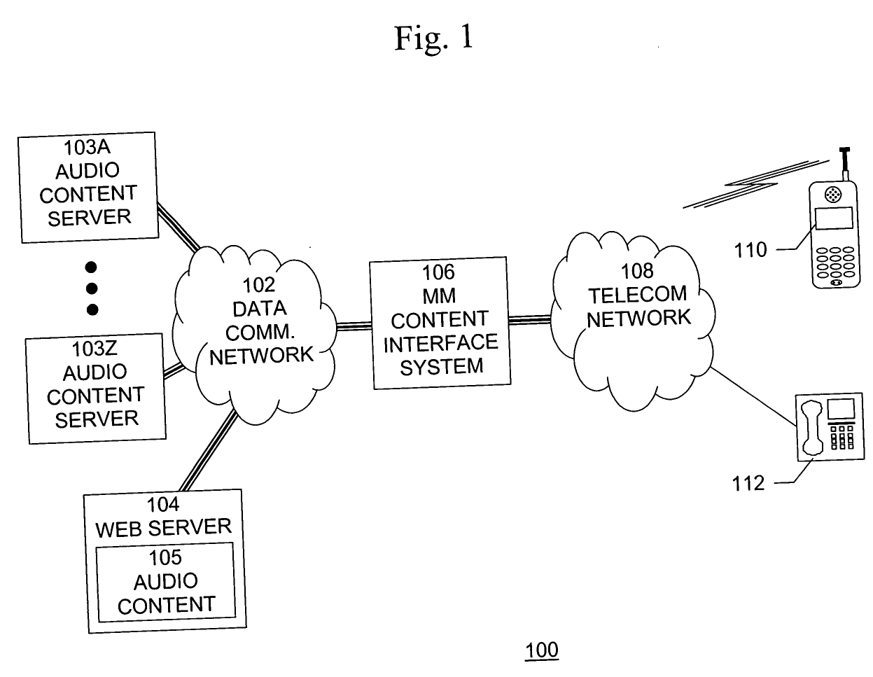

An exemplary block diagram of a network system 100 in which the present invention may be implemented is shown in FIG. 1. Network system 100 includes data communication network 102. Network 102 provides communicative interconnection of a plurality of devices, such as audio content servers 103A-Z. Audio content servers 103A-Z store audio content in digital form and transmit requested audio content over network 102. Typically, an audio content server is implemented as included functionality in another server, such as an Internet Web server, such as Web server 104. Web server 104 includes audio content 105 and transmits requested portions of audio content 105 over network 102.

Network 102 may include both wireless and wireline networks interconnected as appropriate. The transmission medium in a wireless network is typically electromagnetic radiation, such as radio waves or light. The transmission medium in a wireline network is typically copper cable or fiber optic cable. Network 102 may include one or more local area networks (LANs), one or more wide area networks (WANs), or both LANs and WANs. One or more networks may be included in network 102 and may include both public networks, such as the Internet, and private networks and may utilize any networking technology and protocol, such as Ethernet, Token Ring, Transmission Control Protocol/Internet Protocol (TCP/IP), etc. Although not shown in FIG. 1, network 102 may connect, interconnect, or interface with one or more other wireless networks or with one or more wireline networks.

Also connected to network 102 is audio content interface system 106, which interfaces network 102 with telephony network 108. Telecommunications network 108 may include, for example, the Public Switched Telephone Network (PSTN), as well as proprietary local and long distance telecommunications networks. The PSTN and the proprietary telecommunications networks may include wireless and wireline networks interconnected as appropriate. Likewise, a plurality of telephone stations that are typically operated by an end-user, for example, wireless telephones, such as wireless telephone station 110, and wired telephones, such as wired telephone station 112, may be communicatively connected to telecommunications network 108.

Audio content interface system 106 provides delivery of audio content into telephony devices, such as telephone stations 110 and 112. Audio content interface system 106 delivers streaming audio traffic from a data communications network, such as the Internet, to the telephony network. For example, streaming audio Internet content may be delivered to telephone handsets or other devices connected to the telephony network.

It is to be noted that telecommunications network 108 may include a plurality of communications delivery technologies, particularly in when connected to wireless telephone station 110. All telephone stations are provided with a voice connection (either analog or digital) to telecommunications network 108. In addition, telecommunications network 108 may provide data communications delivery technologies, such as Wireless Access Protocol (WAP), which provide the capability for connected devices to communicate data, such as with the Internet, local area networks, etc. The present invention is compatible with the delivery of streaming audio traffic to telephone handsets or other devices connected to the telephony network using any of these communications delivery technologies.

However, in a preferred embodiment, the present invention uses a voice connection (either analog or digital) to deliver streaming audio traffic to telephone handsets or other devices connected to the telephony network. The use of the voice connection provides the advantage that the present invention works with all telephone handsets, since all telephone handsets, wired or wireless, possess a voice connection. By contrast, only wireless handsets may possess data communications delivery technologies, and only a relatively small percentage of wireless handsets possess these technologies. Another advantage of using the voice connection is that the present invention operates on significantly less wireless bandwidth, which means significantly lower cost to the wireless provider.

Audio content interface system 106 has various address protocols that allow the end-user to choose the piece of content to receive. The content selected can be acquired from the public Internet or via a direct feed over a private intranet. This acquired content is then patched into the voice channel of a user's telephone call. This process will support any voice capable telephony user device, including traditional telephone handsets, and mobile handsets.

Audio content interface system 106 supports multiple simultaneous end-users. Each end-user will be delivered the content of their choice. Although end-users can request unrelated pieces of content, the same content can also be requested by more than one end-user.

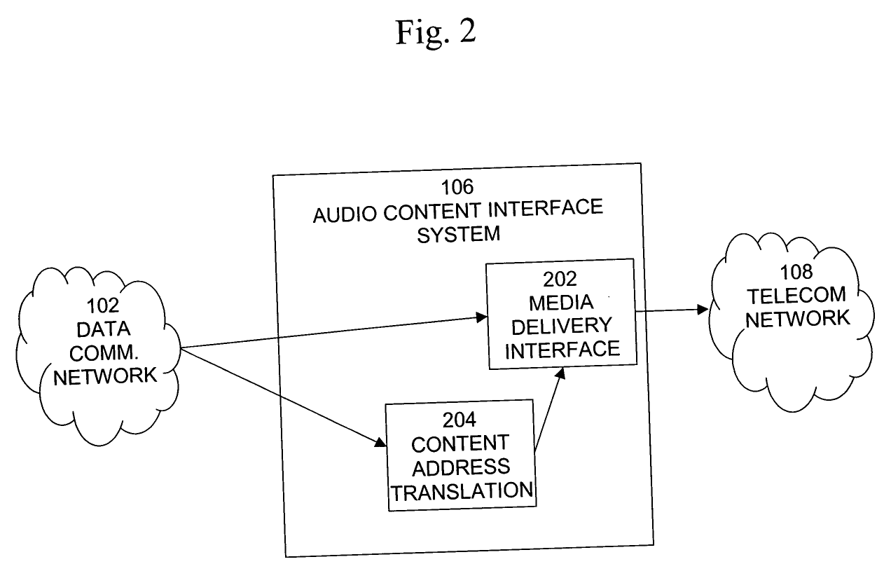

An exemplary block diagram of the audio content interface system 106 is shown in FIG. 2. System 106 includes media delivery interface module 202 and content address translation module 204. The present invention contemplates that each module may be implemented in a variety of ways. For example, each module may be implemented on its own dedicated hardware, or all modules may be implemented on a single shared server.

Media Delivery Interface (MDI) module 202 provides an interface to a telecom network, such as telecom network 108, shown in FIG. 1, that links to the end-user. The end-user dials a telephone number to access MDI 202. MDI 202 supports multiple incoming telephone numbers. Based on the number that is dialed, MDI 202 can present a different user interface and/or a different set of content. It is possible to have a phone number associated with only one piece of content. In this case, the content can begin playing as soon as the system answers the phone. On the other hand, there is no upper limit on the number of pieces of content that can be accessed via a single dial-in number. The issue with large sets of content is in developing a user interface that allows users to easily select one piece of content from a large library. As is discussed later, the product has many different means of indexing and addressing content in order to simplify these user interface issues.

MDI 202 only provides the end-user interface. It does not originate content. Content is streamed into MDI 202, for example, from one or more audio content servers 103A-Z and/or web server 104, when it is requested by the user. Associated with each piece of content requested is a URL. MDI 202 uses this URL to request the streaming content over the network.

If a requested piece of content is already delivered to MDI 202, the new end-user will be connected to the existing content feed. The system will not request two copies of the same content. However, there are two types of content that could be selected: Live or recorded. The system has three different methods for handling these two content types. ‘Live’ content is connected once to MDI 202 and shared among all users. “Recorded-Looping” (RL) content is also connected once and shared among all users. If users are still listening when the RL stream completes, the system automatically loops back to the beginning and continues playing. A user may join the middle of an audio stream and listen through the end and back to the beginning to where they originally joined. Finally, “Recorded-dedicated” (RD) content is offered as a dedicated stream to each user. Every time a new user arrives, they will hear the audio recording from the beginning.

Content Address Translation (CAT) module 204 provides an address map between Internet addresses and telephone access. CAT 204 has several interface options to make it easier to find and access data from the telephone. CAT 204 can contain some pre-indexed URLs. These URLs represent streaming media that is highlighted by CAT 204 because of either a partnership arrangement, or because of the content's value to users. Additionally, the user can program CAT 204 to link to new URLs that represent streaming media sites found by the user.

Several mechanisms will be used to support telephony access to the voice content:

In some cases available content will be limited to a selected set of multimedia streams based on the telephone number used to call the service. This supports the ability to publish a single number that accesses a targeted subset of content. At its extreme, a single content stream will be matched to a dedicated number. This allows end-users who dial the number to immediately hear the content stream. This will also allow easy access to small content subsets. For example, dialing a number to access 30 event-related streams results in a manageable content choice that the user can navigate through using a menu.

In other cases, users will dial numbers that access a larger content library. The user could navigate to selected content using a keyword or numeric index. In order to make the keyword navigation simpler, the system could employee continuous voice recognition with keyword spotting. The user could also access a personalized content selection. When the user dials into the system they would be identified by either the phone number/DNIS of the originating calling device, or by entering a personal identification code when they dial in. This personalized selection system is managed directly by the user through an Internet interface. The user can log in and choose content to be received over the telephone network, and assign personal speed dial numbers to those content items. Alternatively, the user can build a custom login menu using text to speech.

In fact, this ability to create personal content bookmarks would allow users to also bookmark content that is on the public Internet, and that is completely outside the product index. This allows the system to deliver either content belonging to specific partners/sponsors, or to be used as a general purpose streaming audio browser with the ability to deliver any Internet streaming audio.

The user can schedule future delivery of content to a telephone number using the Internet. At a designated future time, the system will call the user and play the pre-selected piece of content. This is useful in the case of events in that it serves as both content delivery and reminder of the event while making the content easy to access. When the selected time arrives, the system automatically calls the user and the content is automatically presented with no menus required. Some stored content is played on a continuous loop. With continuous, stored content, the system can call the user immediately before the content begins to repeat.

Wireless Internet and/or 3G wireless technology will allow simultaneous circuit switched and data access to the product platform. This allows the possibility of multi-mode approaches wherein the menu systems can be delivered visually and the media content can be delivered either via circuit switched channels or data channels.

With callback content delivery the system can also deliver content to other devices such as broadband pagers that have voice reception capability.

CAT 204 can be programmed to control the type of content a user can access. Any given user may have privileges to bookmark only a subset of the data available.

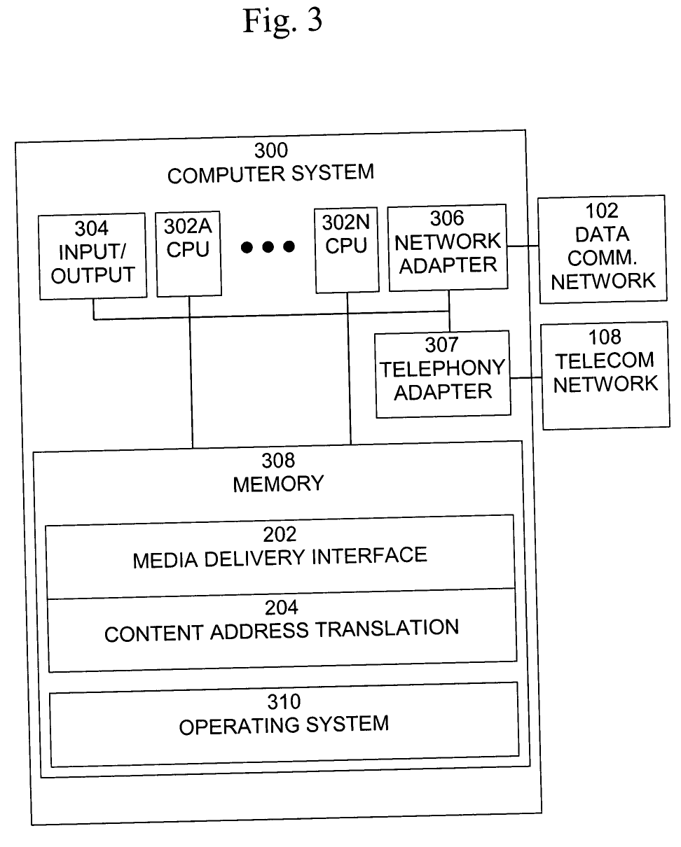

An exemplary block diagram of an audio content interface system 106 shown in FIG. 3. System 106 is typically a programmed general-purpose computer system, such as a personal computer, workstation, server system, and minicomputer or mainframe computer. System 106 includes one or more processors (CPUs) 302A-302N, input/output circuitry 304, network adapter 306, and memory 308. CPUs 302A-302N execute program instructions in order to carry out the functions of the present invention. Typically, CPUs 302A-302N are one or more microprocessors, such as an INTEL PENTIUM® processor. FIG. 3 illustrates an embodiment in which system 106 is implemented as a single multi-processor computer system, in which multiple processors 302A-302N share system resources, such as memory 308, input/output circuitry 304, and network adapter 306. However, the present invention also contemplates embodiments in which system 106 is implemented as a plurality of networked computer systems, which may be single-processor computer systems, multi-processor computer systems, or a mix thereof.

Input/output circuitry 304 provides the capability to input data to, or output data from, system 106. For example, input/output circuitry may include input devices, such as keyboards, mice, touchpads, trackballs, scanners, etc., output devices, such as video adapters, monitors, printers, etc., and input/output devices, such as, modems, etc. Network adapter 306 interfaces system 106 with data communications network 102. Data communications network 102 may include one or more standard local area network (LAN) or wide area network (WAN), such as Ethernet, Token Ring, the Internet, or a private or proprietary LAN/WAN. Telephony adapter 307 interfaces system 106 with telecommunications network 108. Telecommunications network 108 may include, for example, the Public Switched Telephone Network (PSTN), as well as proprietary local and long distance telecommunications networks. The PSTN and the proprietary telecommunications networks may include wireless and wireline networks interconnected as appropriate.

Memory 308 stores program instructions that are executed by, and data that are used and processed by, CPU 302 to perform the functions of system 106. Memory 308 may include electronic memory devices, such as random-access memory (RAM), read-only memory (ROM), programmable read-only memory (PROM), electrically erasable programmable read-only memory (EEPROM), flash memory, etc., and electromechanical memory, such as magnetic disk drives, tape drives, optical disk drives, etc., which may use an integrated drive electronics (IDE) interface, or a variation or enhancement thereof, such as enhanced IDE (EIDE) or ultra direct memory access (UDMA), or a small computer system interface (SCSI) based interface, or a variation or enhancement thereof, such as fast-SCSI, wide-SCSI, fast and wide-SCSI, etc, or a fiber channel-arbitrated loop (FC-AL) interface.

In the example shown in FIG. 3, memory 308 includes media delivery interface (MDI) module 202, content address translation (CAT) module 204, and operating system 310. Media Delivery Interface (MDI) module 202 provides an interface to a telecom network, such as telecom network 108, shown in FIG. 1, that links to the end-user. Content Address Translation (CAT) module 204 provides an address map between Internet addresses and telephone access. Operating system 328 provides overall system functionality.

As shown in FIG. 3, the present invention contemplates implementation on a system or systems that provide multi-processor, multi-tasking, multi-process, and/or multi-thread computing, as well as implementation on systems that provide only single processor, single thread computing. Multi-processor computing involves performing computing using more than one processor. Multi-tasking computing involves performing computing using more than one operating system task. A task is an operating system concept that refers to the combination of a program being executed and bookkeeping information used by the operating system. Whenever a program is executed, the operating system creates a new task for it. The task is like an envelope for the program in that it identifies the program with a task number and attaches other bookkeeping information to it. Many operating systems, including UNIX®, OS/2®, and WINDOWS®, are capable of running many tasks at the same time and are called multitasking operating systems. Multi-tasking is the ability of an operating system to execute more than one executable at the same time. Each executable is running in its own address space, meaning that the executables have no way to share any of their memory. This has advantages, because it is impossible for any program to damage the execution of any of the other programs running on the system. However, the programs have no way to exchange any information except through the operating system (or by reading files stored on the file system). Multi-process computing is similar to multi-tasking computing, as the terms task and process are often used interchangeably, although some operating systems make a distinction between the two.

Audio content interface system 106 may operate on a single hardware platform, or may be distributed geographically. In a distributed environment, each remote geographic location can have its own MDI unit(s). Even in an installation with one centralized location, multiple MDI units may be required. Each MDI has a fixed capacity in terms of simultaneous incoming calls it can support. For capacity reasons, or simply for redundancy, there may be more than one MDI hardware unit in a system. Each MDI can distribute a single media feed to any end-users connected to that MDI who desire the feed. However, in the case of multiple MDIs, each may need to separately request their own copy of the incoming feed from the public Internet.

In some cases it might be desirable to share one media feed across multiple MDIs. A master MDI unit would then use a private network to distribute the feed to the various MDI units that require it. When a customer requests a specific content item, MDI 202 serving the customer would (as long as it was not already receiving the media stream) request the media stream from the central server. The central server would either serve up an existing stream, or acquire the stream from the public Internet. Situations were a central server is required include capacity limitations on the public source, such that it is not able to handle the volume of end-user requests.

Potential cost advantages: third party software and transmission costs may be related to the number of independent media streams delivered. In the case where multiple MDI units are requesting a media stream, it may be advantageous to consolidate the streams into one system stream that the product then distributes throughout its network.

The system may include various options of controlling access and input to the system. These access control options can be tied to an internal or external billing database. Alternatives for input control may include any or none of the following:
Password control to establish origination connections
Metering to control/limit/bill based on
Length/size of content stream
Number of simultaneous accesses
Number of total accesses
Total Access Minutes
Storage Used per Time Period
Time based subscription fees (weekly, monthly, yearly)
Potential to limit input sources to hardwired connections.
Only accept connection from designated sources (IP addresses, URLs, etceteras)
Ability to control which pieces of content are available/tied to a given access method/login/interconnect
Alternatives for end-user access may include any of the methods listed above with the goal of controlling access and potentially linking billing options to access control,
Ability to import external permissions files.

Ability to play sample ‘teaser’ then to request billing information to continue.
Ability to block specific calling numbers automatically after teaser has been played until payment is made.
Ability to block specific calling numbers on a permanent basis.
Advertising

The system may also include the ability to introduce paid advertising into the process. The two types of advertising that could be supported are on the web while accessing CAT 204 interface, and in the actual multi-media stream. Web/CAT advertising would appear just as standard web advertising. However, the in-stream version of the advertising may include several special features:
Ability to schedule advertising content by class of service for improved targeting.
Ability to schedule advertising by specific content item.
Ability to insert advertising before content plays and/or after content plays.
Ability to insert advertising in stream based on a timed advertising interval.

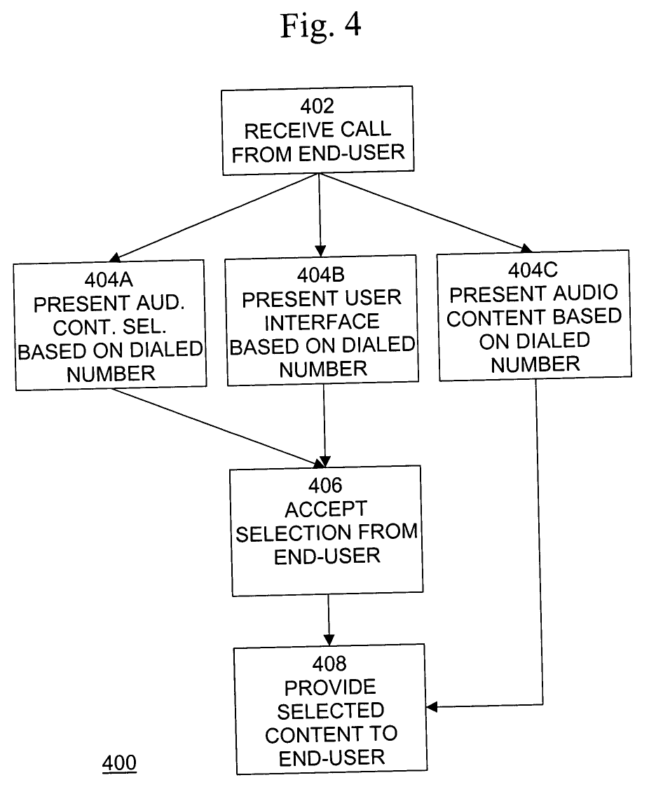

A process of operation 400 of media delivery interface (MDI) 202, shown in FIG. 2, is shown in FIG. 4. Process 400 begins with step 402, in which a call is received from an end-user, who dials a telephone number to access MDI 202. MDI 202 supports multiple incoming telephone numbers. Based on the number that is dialed, MDI 202 can present a different user interface and/or a different set of content. Some examples of this are shown by alternate steps 404A, 404B, and 404C, which may be selected for performance based on the number dialed by the end-user to access MDI 202. In step 404A, audio content selections are presented to the end-user based on the number dialed by the end-user to access MDI 202. In step 404B, a user interface involving more than just audio content selections is presented to the end-user based on the number dialed by the end-user to access MDI 202. In step 404C, audio content not required selection is presented to the end-user based on the number dialed by the end-user to access MDI 202. It is possible to have a phone number associated with only one piece of content. For example, in this case, the content can begin playing as soon as the system answers the phone. On the other hand, there is no upper limit on the number of pieces of content that can be accessed via a single dial-in number.

If step 404A, step 404B, or another step not shown that requires input from the end-user, was performed, process 400 continues with step 406, in which the input or selection from the end-user is accepted. The process then continues with step 408, in which the selected content is provided to the end-user by using the functionality of the content address translation module 204, shown in FIG. 2.

If step 404C, or another step not shown that does not require input from the end-user, was performed, process 400 continues with step 408, in which the selected content is provided to the end-user by using the functionality of the content address translation module 204, shown in FIG. 2. In this case, the content is selected only based on the number dialed by the end-user to access MDI 202, and not on any end-user selections made after the call is connected to MDI 202.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such as floppy disc, a hard disk drive, RAM, and CD-ROM's, as well as transmission-type media, such as digital and analog communications links.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

1. An audio content interface system for providing audio content stored on a data communications network to an end-user over a telecommunications network, the audio content interface system communicatively connected to the data communications network and the telecommunications network, comprising:
a media delivery interface module operable to interface with the end-user over the telecommunications network, accept a request for audio content from the end-user, access audio content over the data communications network, and provide the audio content to the end-user over the telecommunications network; and
a content address translation module operable to provide an address mapping between an address of audio content stored on the data communications network and an address of the end-user on the telecommunications network.

2. The system of claim 1, wherein the audio content is provided to the end-user over a voice connection of the telecommunications network.

3. The system of claim 2, wherein the media delivery interface module is further operable to perform the steps of:
receiving a telephone call from the end-user;
presenting a user interface to the end-user;
accepting a selection of audio content from the end-user; and
providing the selected audio content to the end user.

4. The system of claim 3, wherein the step of presenting a user interface to the end-user comprises the step of:
presenting a different user interface, audio content selections, and/or audio content to the end-user based on a telephone number dialed by the end-user to place the telephone call.

5. The system of claim 4, wherein the step of providing the selected audio content to the end user comprises the steps of:
requesting the selected audio content over the data communications network from a source of audio content using an indicator of a location of the audio content;
receiving over the data communications network the requested audio content; and
providing the requested audio content to the end-user over the telecommunications network.

6. The system of claim 5, wherein there are a plurality of end-users requesting the same audio content and the step of providing the selected audio content to the end-user comprises the step of:
providing the audio content to all end-users that requested the audio content.

7. The system of claim 6, wherein the requested audio content is live audio content and the step of providing the audio content to all end-users that requested the audio content comprises the step of:
providing the audio content to an end-user from a point in the audio content at which the end-user requested the audio content.

8. The system of claim 6, wherein the requested audio content is recorded audio content and the step of providing the audio content to all end-users that requested the audio content comprises the steps of:
providing the audio content to an end-user from a point in the audio content at which the end-user requested the audio content; and
repeating providing the audio content from the start of the audio content.

9. The system of claim 6, wherein the requested audio content is recorded audio content and the step of providing the audio content to all end-users that requested the audio content comprises the step of:
providing the audio content from the start of the audio content for each end-user that requests the audio content.

10. The system of claim 3, wherein the media delivery interface module is further operable to perform the step of:
controlling access and/or input to the media delivery interface module.

11. The system of claim 10, wherein the step of controlling access and/or input to the media delivery interface module comprises at least one of:
providing password control to establish origination connections;
metering to control, limit, and/or bill based on a length or size of the audio content, a number of simultaneous accesses to the audio content, a number of total accesses to the audio content, a time of access to the audio content, and/or periodic charges;
limiting input sources to hardwired connections;
accept connection only from designated sources;
controlling which pieces of content are available based on an access method, login, and/or interconnect;
importing an external permissions file;
providing a sample audio content, then requiring billing information to continue providing audio content;
blocking specific calling numbers automatically after sample audio content has been provided, until payment is made; and
blocking specific calling numbers permanently.

12. The system of claim 11, wherein the media delivery interface module is further operable to perform the step of:
providing advertising content to the end-user.

13. The system of claim 12, wherein the step of providing advertising content to the end-user comprises at least one of:
providing advertising content by class of service;
providing advertising content based on selected audio content;
providing advertising content before and/or after providing selected audio content; and
providing advertising content based on a timed advertising interval.

14. The system of claim 3, wherein the media delivery interface module is further operable to perform the step of:
requesting the selected audio content from a Web server.

15. The system of claim 14, wherein the step of the requesting the selected audio content from a Web server comprises the step of:
requesting the selected audio content from the Web server using a uniform resource locator.

16. The system of claim 15, wherein the data communications network is the Internet.

17. The system of claim 3, wherein the media delivery interface module is further operable to perform the step of:
requesting the selected audio content from an audio content server.

18. The system of claim 17, wherein the step of the requesting the selected audio content from the audio content server comprises the step of:
requesting the selected audio content from the audio content server using a uniform resource locator.

19. The system of claim 18, wherein the data communications network is the Internet.

20. In an audio content interface system for providing audio content stored on a data communications network to an end-user over a telecommunications network, the audio content interface system communicatively connected to the data communications network and the telecommunications network, a method for providing audio content comprising the steps of:
accepting a request for audio content from the end-user;
accessing audio content over the data communications network;
providing the audio content to the end-user over the telecommunications network; and
providing an address mapping between an address of audio content stored on the data communications network and an address of the end-user on the telecommunications network.

21. The method of claim 20, wherein the audio content is provided to the end-user over a voice connection of the telecommunications network.

22. The method of claim 21, wherein the step of accepting a request for audio content from the end-user comprises the steps of:
receiving a telephone call from the end-user;
presenting a user interface to the end-user; and
accepting a selection of audio content from the end-user.

23. The method of claim 22, wherein the step of providing the audio content to the end-user over the telecommunications network comprises the step of:
providing the selected audio content to the end user.

24. The method of claim 23, wherein the step of presenting a user interface to the end-user comprises the step of:
presenting a different user interface, audio content selections, and/or audio content to the end-user based on a telephone number dialed by the end-user to place the telephone call.

25. The method of claim 24, wherein the step of providing the selected audio content to the end user comprises the steps of:
requesting the selected audio content over the data communications network from a source of audio content using an indicator of a location of the audio content;
receiving over the data communications network the requested audio content; and
providing the requested audio content to the end-user over the telecommunications network.

26. The method of claim 25, wherein there are a plurality of end-users requesting the same audio content and the step of providing the selected audio content to the end-user comprises the step of:
providing the audio content to all end-users that requested the audio content.

27. The method of claim 26, wherein the requested audio content is live audio content and the step of providing the audio content to all end-users that requested the audio content comprises the step of:
providing the audio content to an end-user from a point in the audio content at which the end-user requested the audio content.

28. The method of claim 26, wherein the requested audio content is recorded audio content and the step of providing the audio content to all end-users that requested the audio content comprises the steps of:
providing the audio content to an end-user from a point in the audio content at which the end-user requested the audio content; and
repeating providing the audio content from the start of the audio content.

29. The method of claim 26, wherein the requested audio content is recorded audio content and the step of providing the audio content to all end-users that requested the audio content comprises the step of:
providing the audio content from the start of the audio content for each end-user that requests the audio content.

30. The method of claim 23, further comprising the step of:
controlling access and/or input to the media delivery interface module.

31. The method of claim 30, wherein the step of controlling access and/or input to the media delivery interface module comprises at least one of:
providing password control to establish origination connections;
metering to control, limit, and/or bill based on a length or size of the audio content, a number of simultaneous accesses to the audio content, a number of total accesses to the audio content, a time of access to the audio content, and/or periodic charges;
limiting input sources to hardwired connections;
accept connection only from designated sources;
controlling which pieces of content are available based on an access method, login, and/or interconnect;
importing an external permissions file;
providing a sample audio content, then requiring billing information to continue providing audio content;
blocking specific calling numbers automatically after sample audio content has been provided, until payment is made; and
blocking specific calling numbers permanently.

32. The method of claim 31, further comprising the step of:
providing advertising content to the end-user.

33. The method of claim 32, wherein the step of providing advertising content to the end-user comprises at least one of:
providing advertising content by class of service;
providing advertising content based on selected audio content;
providing advertising content before and/or after providing selected audio content; and
providing advertising content based on a timed advertising interval.

34. The method of claim 22, wherein the media delivery interface module is further operable to perform the step of:
requesting the selected audio content from a Web server.

35. The method of claim 34, wherein the step of the requesting the selected audio content from a Web server comprises the step of:
requesting the selected audio content from the Web server using a uniform resource locator.

36. The method of claim 35, wherein the data communications network is the Internet.

37. The method of claim 22, wherein the media delivery interface module is further operable to perform the step of:
requesting the selected audio content from an audio content server.

38. The method of claim 37, wherein the step of the requesting the selected audio content from the audio content server comprises the step of:
requesting the selected audio content from the audio content server using a uniform resource locator.

39. The method of claim 38, wherein the data communications network is the Internet.

40. A computer program product for an audio content interface system for providing audio content stored on a data communications network to an end-user over a telecommunications network, the audio content interface system communicatively connected to the data communications network and the telecommunications network, the computer program product for performing a workflow process in an electronic commerce system, comprising a computer readable medium and computer program instructions, recorded on the computer readable medium, executable by a processor, for performing the steps of:
accepting a request for audio content from the end-user;
accessing audio content over the data communications network;
providing the audio content to the end-user over the telecommunications network; and
providing an address mapping between an address of audio content stored on the data communications network and an address of the end-user on the telecommunications network.

41. The computer program product of claim 40, wherein the audio content is provided to the end-user over a voice connection of the telecommunications network.

42. The computer program product of claim 41, wherein the step of accepting a request for audio content from the end-user comprises the steps of:
receiving a telephone call from the end-user;
presenting a user interface to the end-user; and
accepting a selection of audio content from the end-user.

43. The computer program product of claim 42, wherein the step of providing the audio content to the end-user over the telecommunications network comprises the step of:
providing the selected audio content to the end user.

44. The computer program product of claim 43, wherein the step of presenting a user interface to the end-user comprises the step of:
presenting a different user interface, audio content selections, and/or audio content to the end-user based on a telephone number dialed by the end-user to place the telephone call.

45. The computer program product of claim 44, wherein the step of providing the selected audio content to the end user comprises the steps of:
requesting the selected audio content over the data communications network from a source of audio content using an indicator of a location of the audio content;
receiving over the data communications network the requested audio content; and
providing the requested audio content to the end-user over the telecommunications network.

46. The computer program product of claim 45, wherein there are a plurality of end-users requesting the same audio content and the step of providing the selected audio content to the end-user comprises the step of:
providing the audio content to all end-users that requested the audio content.

47. The computer program product of claim 46, wherein the requested audio content is live audio content and the step of providing the audio content to all end-users that requested the audio content comprises the step of:
providing the audio content to an end-user from a point in the audio content at which the end-user requested the audio content.

48. The computer program product of claim 46, wherein the requested audio content is recorded audio content and the step of providing the audio content to all end-users that requested the audio content comprises the steps of:
providing the audio content to an end-user from a point in the audio content at which the end-user requested the audio content; and
repeating providing the audio content from the start of the audio content.

49. The computer program product of claim 46, wherein the requested audio content is recorded audio content and the step of providing the audio content to all end-users that requested the audio content comprises the step of:
providing the audio content from the start of the audio content for each end-user that requests the audio content.

50. The computer program product of claim 43, further comprising the step of:
controlling access and/or input to the media delivery interface module.

51. The computer program product of claim 50, wherein the step of controlling access and/or input to the media delivery interface module comprises at least one of:
providing password control to establish origination connections;
metering to control, limit, and/or bill based on a length or size of the audio content, a number of simultaneous accesses to the audio content, a number of total accesses to the audio content, a time of access to the audio content, and/or periodic charges;
limiting input sources to hardwired connections;
accept connection only from designated sources;
controlling which pieces of content are available based on an access method, login, and/or interconnect;
importing an external permissions file;
providing a sample audio content, then requiring billing information to continue providing audio content;
blocking specific calling numbers automatically after sample audio content has been provided, until payment is made; and
blocking specific calling numbers permanently.

52. The computer program product of claim 51, further comprising the step of:
providing advertising content to the end-user.

53. The computer program product of claim 52, wherein the step of providing advertising content to the end-user comprises at least one of:
providing advertising content by class of service;
providing advertising content based on selected audio content;
providing advertising content before and/or after providing selected audio content; and
providing advertising content based on a timed advertising interval.

54. The computer program product of claim 42, wherein the media delivery interface module is further operable to perform the step of:
requesting the selected audio content from a Web server.

55. The computer program product of claim 54, wherein the step of the requesting the selected audio content from a Web server comprises the step of:
requesting the selected audio content from the Web server using a uniform resource locator.

56. The computer program product of claim 55, wherein the data communications network is the Internet.

57. The computer program product of claim 42, wherein the media delivery interface module is further operable to perform the step of:
requesting the selected audio content from an audio content server.

58. The computer program product of claim 57, wherein the step of the requesting the selected audio content from the audio content server comprises the step of:
requesting the selected audio content from the audio content server using a uniform resource locator.

59. The computer program product of claim 58, wherein the data communications network is the Internet.
